(19) United States
(12) Patent Application Publication
(10) Pub. No.: US 2013/0038855 A1
(43) Pub. Date: Feb. 14, 2013

(54) LITHOGRAPHY APPARATUS AND MANUFACTURING METHOD OF COMMODITIES

(71) Applicant: Kiyohito YAMAMOTO, Utsunomiya-shi (JP)

(72) Inventor: Kiyohito YAMAMOTO, Utsunomiya-shi (JP)

(73) Assignee: CANON KABUSHIKI KAISHA, Tokyo (JP)

(21) Appl. No.: 13/570,381

(22) Filed: Aug. 9, 2012

(30) Foreign Application Priority Data
Aug. 12, 2011 (JP) 2011-177252

(51) Int. Cl. G03B 27/64

(52) U.S. Cl. 355/76; 355/77

(57) ABSTRACT

The present invention provides a lithography apparatus which transfers a pattern onto a substrate using an original including a pattern region in which the pattern is formed, the apparatus including a stocker configured to store the original, a processing unit configured to perform a transfer process of transferring the pattern onto the substrate, and a conveyance hand configured to convey the original between the stocker and the processing unit, wherein the conveyance hand includes a protective plate configured to protect the pattern region upon being placed to cover the pattern region, and a holding portion configured to hold the original via a portion other than the pattern region of the original upon being placed on the protective plate.

### BACKGROUND OF THE INVENTION

1. Field of the Invention

The present invention relates to a lithography apparatus and a manufacturing method of commodities.

2. Description of the Related Art

As lithography apparatuses employed to manufacture semiconductor devices, an imprint apparatus capable of manufacturing semiconductor devices in large quantities at a low cost without requiring a large-scale apparatus for, for example, a vacuum process is attracting a great deal of attention, in addition to an exposure apparatus which projects the pattern of a reticle onto a substrate. The imprint apparatus cures a resin on a substrate (a silicon wafer or a glass plate) to transfer the pattern while a mold (original) having a pattern (three-dimensional pattern) is pressed against the resin, using the imprint technology.

In the imprint apparatus, when a particle (a foreign substance such as dust) adheres to the pattern surface of the mold, it leads to a defect of a pattern to be transferred onto the substrate or damage to this pattern surface, so it is necessary to prevent particles from adhering to this pattern surface. For example, in the exposure apparatus, a pellicle is placed on the side of the pattern surface of the reticle (original) to prevent particles from adhering to this pattern surface, but in the imprint apparatus, no pellicle can be placed on the side of the pattern surface of the mold because the mold is brought into contact with the resin on the substrate. Again, in the exposure apparatus, Japanese Patent Laid-Open No. 2006-245257 discloses a cassette which accommodates reticles to protect their pattern surfaces in a non-contact state, as a technique of preventing particles from adhering to these pattern surfaces. In the technique described in Japanese Patent Laid-Open No. 2006-245257, reticles are conveyed together with a cassette accommodating them, because particles are more likely to adhere to the pattern surfaces of the reticles being conveyed.

However, in the technique described in Japanese Patent Laid-Open No. 2006-245257, a cassette for accommodating reticles has a complicated structure, and a conveyance mechanism dedicated to conveying a cassette accommodating reticles is necessary, leading to disadvantages in apparatus configuration and apparatus cost. Therefore, it is impractical to apply the technique disclosed in Japanese Patent Laid-Open No. 2006-245257 to an imprint apparatus capable of manufacturing semiconductor devices at a low cost.

### SUMMARY OF THE INVENTION

The present invention provides a technique advantageous in preventing particles from adhering to an original.

According to one aspect of the present invention, there is provided a lithography apparatus which transfers a pattern onto a substrate using an original including a pattern region in which the pattern is formed, the apparatus comprising: a stocker configured to store the original; a processing unit configured to perform a transfer process of transferring the pattern onto the substrate; and a conveyance hand configured to convey the original between the stocker and the processing unit, wherein the conveyance hand includes: a protective plate configured to protect the pattern region upon being placed to cover the pattern region, and a holding portion configured to hold the original via a portion other than the pattern region of the original upon being placed on the protective plate.

Further features of the present invention will become apparent from the following description of exemplary embodiments with reference to the attached drawings.

### BRIEF DESCRIPTION OF THE DRAWINGS

FIG. 1 is a side view showing the configuration of a conveyance mechanism applied to a lithography apparatus according to an aspect of the present invention.

FIG. 2 is a schematic top view showing the configuration of the conveyance mechanism shown in FIG. 1.

FIGS. 3A to 3F are views for explaining the lithography apparatus according to the aspect of the present invention.

FIG. 4 is a view showing the configuration of a stocker in the lithography apparatus shown in FIGS. 3A to 3F.

FIG. 5 is a side view showing another configuration of the conveyance mechanism applied to the lithography apparatus according to the aspect of the present invention.

FIG. 6 is a side view showing still another configuration of the conveyance mechanism applied to the lithography apparatus according to the aspect of the present invention.

### DESCRIPTION OF THE EMBODIMENTS

Preferred embodiments of the present invention will be described below with reference to the accompanying drawings. Note that the same reference numerals denote the same members throughout the drawings, and a repetitive description thereof will not be given.

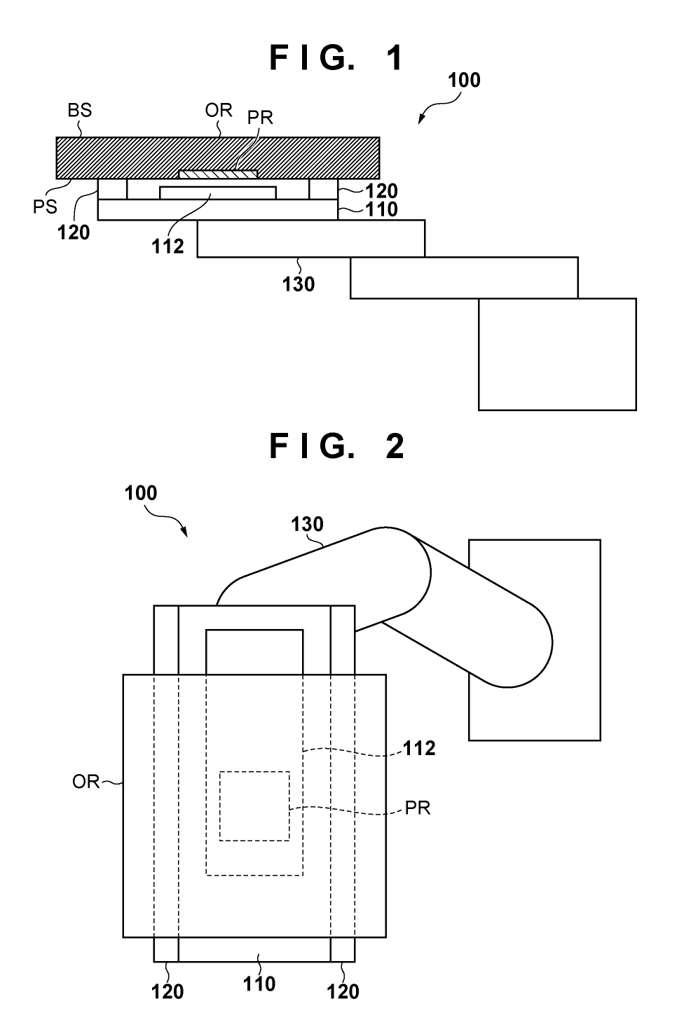

FIG. 1 is a schematic side view showing the configuration of a conveyance mechanism 100 applied to a lithography apparatus according to an aspect of the present invention. FIG. 2 is a schematic top view showing the configuration of the conveyance mechanism 100. The conveyance mechanism 100 conveys an original OR to be used in a transfer process of transferring a pattern onto a substrate in the lithography apparatus. The original OR includes a pattern region PR in which a pattern to be transferred onto the substrate is formed. In this specification, the surface of the original OR, which includes the pattern region PR, will be referred to as a pattern surface PS hereinafter, and the surface of the original OR, which is opposite to that (pattern surface PS) including the pattern region PR, will be referred to as a back surface BS hereinafter.

The conveyance mechanism 100 includes a protective plate 110 which is placed to cover the pattern region PR of the original OR with a gap from it (that is, in non-contact with it), and protects the pattern region PR. The protective plate 110 has an area larger than that of the pattern region PR to the degree that it does not separate from the pattern region PR even if the position of the original OR held by a holding portion 120 (to be described later) has shifted.

The holding portion 120 which holds the original OR via a portion other than the pattern region PR of the original OR, for example, via a portion other than the pattern region PR on the pattern surface PS is placed on the protective plate 110. The holding portion 120 is implemented by, for example, an absorption pad which absorbs the original OR by vacuum absorption. Also, the holding portion 120 holds the original OR at a position spaced apart from the pattern region PR so that particles generated as the holding portion 120 comes into contact with the original OR to hold it are prevented from adhering to the pattern region PR. For example, the holding portion 120 may hold the original OR via the back surface BS of the original OR, as will be described later.

The holding portion 120 holds the original OR while leaving a gap as very narrow as, for example, 10 μm or less between the protective plate 110 (its surface) and the pattern region PR (pattern surface PS) of the original OR. This makes it possible to suppress entrance of particles into the space between the protective plate 110 and the pattern region PR of the original OR, thereby preventing these particles from adhering to the pattern region PR. Note that a step portion 112 having a shape convex toward the original OR may be formed on the protective plate 110 so that the holding portion 120 holds the original OR while leaving a very narrow gap between the step portion 112 and the pattern region PR of the original OR, as shown in FIGS. 1 and 2.

A conveyance hand 130 is a movable hand which moves upon holding the protective plate 110. The conveyance hand 130 can adopt any configuration known to those skilled in the art, and is capable of moving, for example, between a stocker which stores the original OR and a processing unit which performs a transfer process of transferring the pattern of the original OR onto the substrate in the lithography apparatus.

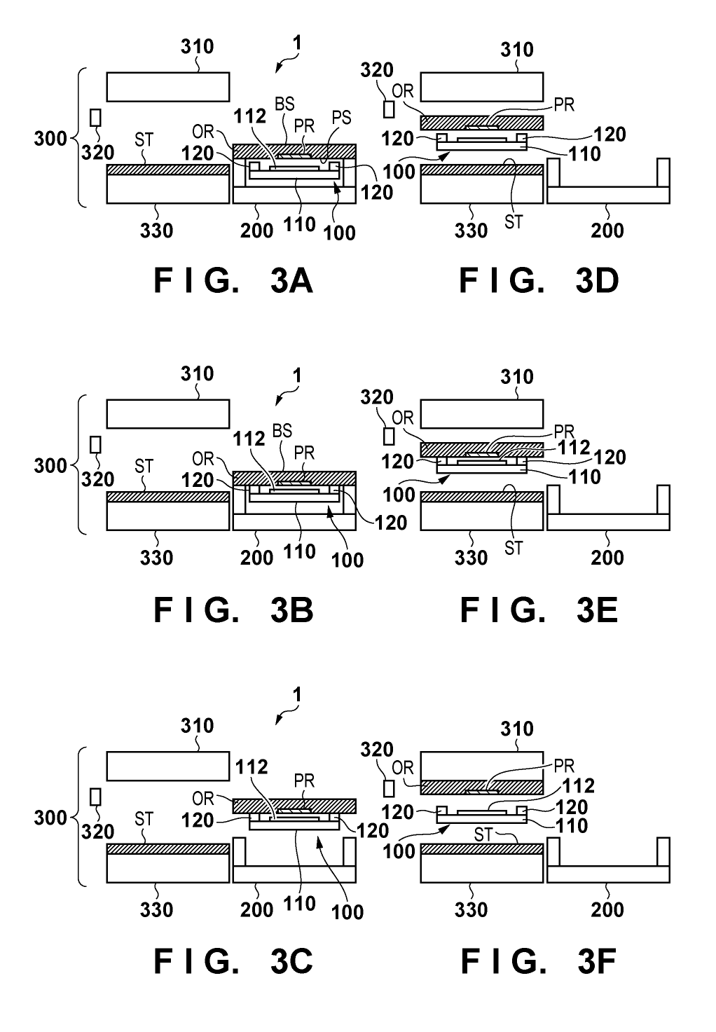

A lithography apparatus 1 according to an aspect of the present invention will be described with reference to FIGS. 3A to 3F. The lithography apparatus 1 transfers onto a substrate ST the pattern of the original OR having the pattern region PR in which a pattern is formed, and is embodied as, for example, an imprint apparatus or an exposure apparatus. The lithography apparatus 1 includes a stocker 200 which stores the original OR, a processing unit 300 which performs a transfer process of transferring the pattern of the original OR onto the substrate ST, and the conveyance mechanism 100 which conveys the original OR between the stocker 200 and the processing unit 300, as shown in FIGS. 3A to 3F. Note that the conveyance hand 130 of the conveyance mechanism 100 is not illustrated in FIGS. 3A to 3F.

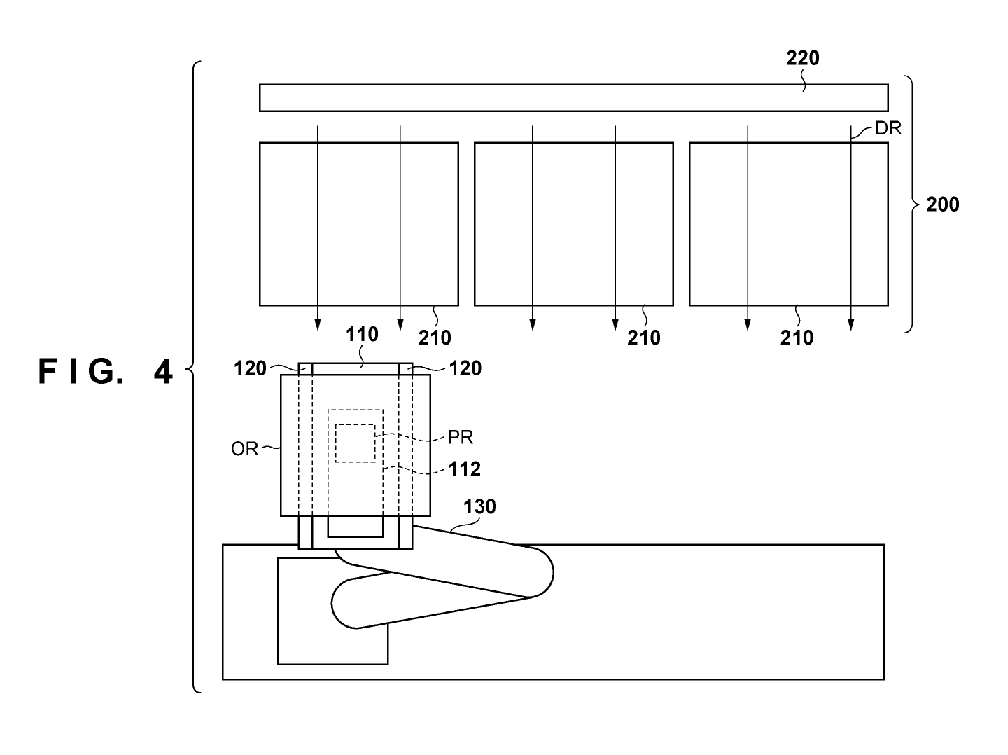

The stocker 200 and processing unit 300 are arranged in an air-conditioned environment in which the air current is controlled. More specifically, the stocker 200 includes a plurality of mounting units 210 which mount originals OR, and a storage environment forming unit 220 which forms an air current in a direction DR along the pattern surface PS of the original OR, as shown in FIG. 4. In the stocker 200, while each mounting unit 210 mounts the original OR, the storage environment forming unit 220 forms an air current in the direction DR along the pattern surface PS of the original OR to prevent particles from adhering to the pattern region PR. Also, when an ionizer is placed upstream in the air current formed by the storage environment forming unit 220 to remove electrostatic forces that generate charges in particles and the original OR, these particles can more reliably be prevented from adhering to the pattern region PR. Note that the direction DR of the air current formed by the storage environment forming unit 220 is not limited to the downward direction, as shown in FIG. 4, and may be, for example, the upward, rightward, or leftward direction. Similarly, the processing unit 300 includes an original stage 310 which holds the original OR, and a processing environment forming unit 320 which forms an air current in the direction along the pattern surface PS of the original OR. In the processing unit 300, while the original stage 310 holds the original OR, the processing environment forming unit 320 forms an air current in the direction DR along the pattern surface PS of the original OR, thereby preventing particles from adhering to the pattern region PR.

The processing unit 300 includes, for example, a substrate stage 330 which holds the substrate ST, in addition to the original stage 310 and processing environment forming unit 320. If the lithography apparatus 1 is an imprint apparatus, the processing unit 300 performs an imprint process of curing a resin, dispensed on the substrate ST, while the original OR is pressed against the resin, and peeling the original OR off the cured resin. In this case, the processing unit 300 includes, for example, a resin supply mechanism which supplies a resin onto the substrate ST, and a driving mechanism which drives the original stage 310 to press a mold serving as the original OR against the resin on the substrate ST or separate the mold from the resin. On the other hand, if the lithography apparatus 1 is an exposure apparatus, the processing unit 300 includes, for example, an illumination optical system and projection optical system, and performs an exposure process of projecting the pattern of a reticle serving as the original OR onto the substrate ST via the projection optical system.

How to convey the original OR by the conveyance mechanism 100 in the lithography apparatus 1 will be explained below. FIG. 3A shows the state in which the stocker 200 stores the original OR. Referring to FIG. 3A, an air current formed by the storage environment forming unit 220 prevents particles from adhering to the pattern region PR of the original OR, as described above. To receive the original OR stored in the stocker 200, the conveyance mechanism 100 moves the conveyance hand 130 so that the holding portion 120 placed on the protective plate 110 holds the original OR, as shown in FIG. 3B.

To convey the original OR to the processing unit 300, the conveyance mechanism 100 moves the conveyance hand 130 while the holding portion 120 holds the original OR, as shown in FIGS. 3C and 3D. As shown in FIG. 3E, after the conveyance hand 130 moves to the position at which it transfers the original OR onto the original stage 310, the original stage 310 starts to hold the original OR, and the holding portion 120 cancels the holding of the original OR.

When the original stage 310 holds the original OR, the conveyance mechanism 100 moves the conveyance hand 130 to retract itself from the processing unit 300, as shown in FIG. 3F. FIG. 3F shows the state in which the original stage 310 holds the original OR. Referring to FIG. 3F, an air current formed by the processing environment forming unit 320 prevents particles from adhering to the pattern region PR of the original OR, as described above.

FIGS. 3B to 3F show the states in which the conveyance mechanism 100 conveys the original OR from the stocker 200 to the processing unit 300. At this time, the air current near the pattern region PR of the original OR is disturbed due to the operation of the conveyance mechanism 100 (that is, the movement of the conveyance hand 130). However, in the conveyance mechanism 100, the protective plate 110 and the pattern region PR of the original OR have a very narrow gap between them while the holding portion 120 holds the original OR, as described above. This makes it possible to suppress entrance of particles into the gap between the protective plate 110 and the pattern region PR of the original OR, thereby preventing these particles from adhering to the pattern region PR.

Also, in conveying the original OR held by the original stage 310 from the processing unit 300 to the stocker 200, the above-mentioned operations shown in FIGS. 3F, 3E, 3D, 3C, 3B, and 3A need only be done in this order. When the original OR is conveyed from the processing unit 300 to the stocker 200 as well, it is possible to suppress entrance of particles into the gap between the protective plate 110 and the pattern region PR of the original OR, thereby preventing these particles from adhering to the pattern region PR.

Further, the conveyance mechanism 100 stands by in an air-conditioned environment in which the air current is controlled, while it does not convey the original OR. When a particle is adhering on the protective plate 110, it may come off the protective plate 110 and adhere to the pattern region PR of the original OR upon conveyance of the original OR. Hence, while the holding portion 120 does not hold the original OR and the surface of the protective plate 110 is exposed (that is, while the conveyance mechanism 100 does not convey the original OR), an air current is formed in a direction along the surface of the protective plate 110. This makes it possible to prevent particles from adhering to the protective plate 110. Also, when an ionizer is placed upstream in the air current to remove electrostatic forces that generate charges in particles and the protective plate 110, these particles can more reliably be prevented from adhering to the protective plate 110.

In this manner, the lithography apparatus 1 of this embodiment can prevent particles from adhering to the pattern region PR during conveyance of the original OR, using a conveyance mechanism 100 having a simple configuration. Also, even when the stocker 200 stores the original OR or the original stage 310 holds the original OR, particles can be prevented from adhering to the pattern region PR by forming an air current in a direction along the pattern region PR of the original OR. Hence, the lithography apparatus 1 can provide a high-quality device (for example, a semiconductor device, an LCD device, an image sensing device (for example, a CCD), or a thin-film magnetic head) with a high throughput and good economic efficiency with neither complication of the apparatus configuration nor an increase in apparatus cost. A manufacturing method of devices as commodities includes a step of transferring the pattern of an original onto a substrate (for example, a wafer, a glass plate, or a film-like substrate) using the lithography apparatus 1. The manufacturing method further includes a step of etching the substrate having the pattern transferred on it. Note that in manufacturing other commodities such as pattern dot media (recording media) or optical devices, the manufacturing method includes other processing steps of processing the substrate having the pattern transferred on it, in place of an etching step.

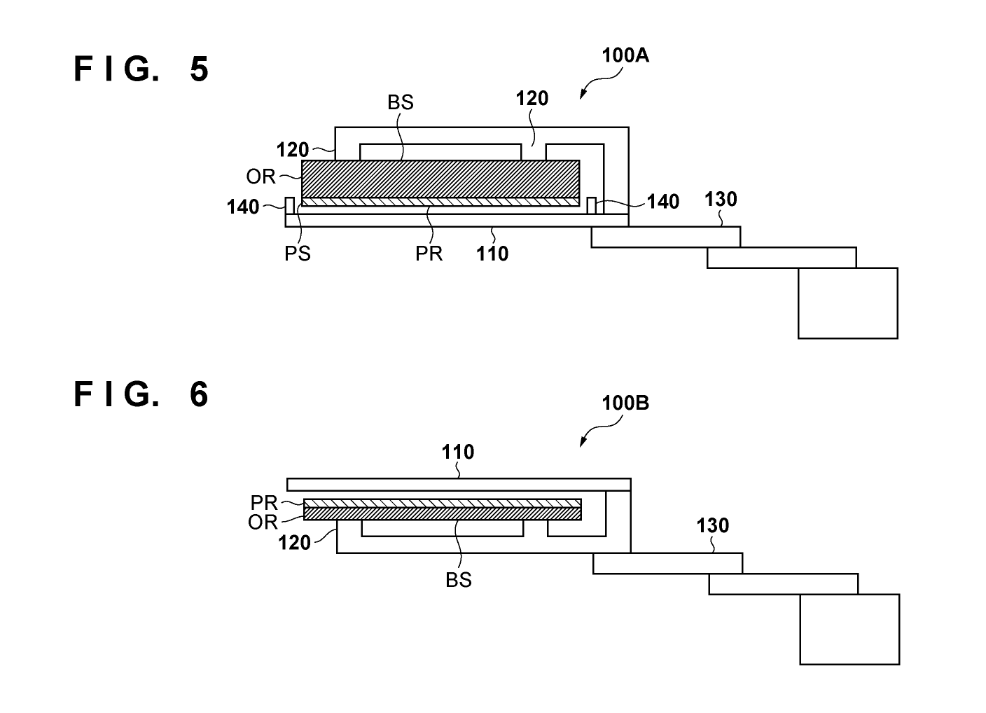

The conveyance mechanism 100 can also be substituted with a conveyance mechanism 100A shown in FIG. 5. FIG. 5 is a schematic side view showing the configuration of the conveyance mechanism 100A applied to the lithography apparatus 1. The conveyance mechanism 100A is suitable for conveying an original OR including a pattern region PR formed on its entire pattern surface PS. Since the holding portion 120 cannot hold the original OR via a portion other than the pattern region PR on the pattern surface PS, it holds the original OR via a back surface BS of the original OR, as shown in FIG. 5.

The conveyance mechanism 100A includes a protective member 140, in addition to the protective plate 110, holding portion 120, and conveyance hand 130. The protective member 140 is placed on the protective plate 110 so as to surround the two opposed sides of the pattern surface PS of the original OR, while extending in a direction perpendicular to the pattern surface PS of the original OR. This makes it possible to more reliably suppress entrance of particles into the space between the protective plate 110 and the pattern region PR of the original OR, thereby more reliably preventing these particles from adhering to the pattern region PR.

The conveyance mechanism 100 can moreover be substituted with a conveyance mechanism 100B shown in FIG. 6. FIG. 6 is a schematic side view showing the configuration of the conveyance mechanism 100B applied to the lithography apparatus 1. The conveyance mechanism 100B is suitable for conveying an original OR including a pattern region PR formed on its entire pattern surface PS, like the conveyance mechanism 100A. Since the holding portion 120 cannot hold the original OR via a portion other than the pattern region PR on the pattern surface PS, it holds the original OR via a back surface BS of the original OR, as shown in FIG. 6. Also, the holding portion 120 holds the original OR upon orienting the back surface BS of the original OR in the direction of gravity.

In the conveyance mechanism 100B as well, the holding portion 120 holds the original OR while leaving a gap as very narrow as, for example, 10 μm or less between a protective plate 110 and the pattern region PR of the original OR. This makes it possible to suppress entrance of particles into the space between the protective plate 110 and the pattern region PR of the original OR, thereby preventing these particles from adhering to the pattern region PR.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-177252 filed on Aug. 12, 2011, which is hereby incorporated by reference herein in its entirety.

What is claimed is:

1. A lithography apparatus which transfers a pattern onto a substrate using an original including a pattern region in which the pattern is formed, the apparatus comprising:
a stocker configured to store the original;
a processing unit configured to perform a transfer process of transferring the pattern onto the substrate; and
a conveyance hand configured to convey the original between the stocker and the processing unit,
wherein the conveyance hand includes:
a protective plate configured to protect the pattern region upon being placed to cover the pattern region, and
a holding portion configured to hold the original via a portion other than the pattern region of the original upon being placed on the protective plate.

2. The apparatus according to claim 1, wherein the holding portion holds the original via the portion other than the pattern region on a surface of the original, which includes the pattern region.

3. The apparatus according to claim 1, wherein the holding portion holds the original via a surface of the original, which is opposite to a surface thereof including the pattern region.

4. The apparatus according to claim 3, wherein the conveyance hand further includes a protective member placed on the protective plate so as to cover two opposed sides of the surface including the pattern region, while extending in a direction perpendicular to the surface including the pattern region.

5. The apparatus according to claim 3, wherein the holding portion holds the original upon orienting in the direction of gravity the surface of the original, which is opposite to the surface thereof including the pattern region.

6. The apparatus according to claim 1, wherein the stocker includes
a mounting unit configured to mount the original, and
a storage environment forming unit configured to form an air current in a direction along a surface of the original, which includes the pattern region, while the mounting portion mounts the original.

7. The apparatus according to claim 1, wherein the processing unit includes
a stage configured to hold the original, and
a processing environment forming unit configured to form an air current in a direction along a surface of the original, which includes the pattern region, while the stage holds the original.

8. The apparatus according to claim 1, wherein the processing unit performs, as the transfer process, an imprint process of curing a resin, dispensed on the substrate, while the original is pressed against the resin, and peeling the original off the cured resin.

9. The apparatus according to claim 1, wherein the processing unit performs, as the transfer process, an exposure process of projecting the pattern of the original onto the substrate via a projection optical system.

10. A manufacturing method of commodities comprising:
a step of using a lithography apparatus to transfer a pattern of an original including a pattern region in which the pattern is formed onto a substrate; and
a step of processing the substrate with the pattern,
wherein the lithography apparatus includes:
a stocker configured to store the original;
a processing unit configured to perform a transfer process of transferring the pattern onto the substrate; and
a conveyance hand configured to convey the original between the stocker and the processing unit,
the conveyance hand includes:
a protective plate configured to protect the pattern region upon being placed to cover the pattern region, and
a holding portion configured to hold the original via a portion other than the pattern region of the original upon being placed on the protective plate.
